(19) United States
(12) Patent Application Publication
(10) Pub. No.: US 2026/0246047 A1
(43) Pub. Date: Aug. 20, 2026

(54) Battery Packaging System and Battery Pack Including the Same

(71) Applicant: LG Energy Solution, Ltd., Seoul (KR)

(72) Inventors: Eun Suk Park, Daejeon (KR); Yu Jin Lee, Daejeon (KR); Hye Yeong Ju, Daejeon (KR); Kyun II Rah, Daejeon (KR); Hyung Kyun Yu, Daejeon (KR)

(73) Assignee: LG Energy Solution, Ltd., Seoul (KR)

(21) Appl. No.: 19/539,855

(22) Filed: Feb. 13, 2026

(30) Foreign Application Priority Data
Feb. 17, 2025 (KR) 10-2025-0020436

(51) Int. Cl. H01M 50/213; H01M 10/0525; H01M 10/613

(52) U.S. Cl. CPC H01M 50/213; H01M 10/0525; H01M 10/613; H01M 2220/20

(57) ABSTRACT

A battery packaging system includes a battery packaging that accommodates a plurality of battery cells and an insulating oil. Each of the plurality of battery cells includes: an electrode lead that protrudes outward from a short side of the battery case and performs electrical connection; and an insulating unit that surrounds the electrode lead and insulates the battery case and the electrode lead from each other. The battery packaging system has an STR value of 12.5 or more, the STR value being represented as a ratio of a difference (|ST₁−ST_{F}|) between a surface tension of the insulating oil and a surface energy (ST_{F}) of the insulating unit to the surface energy (ST_{F}) of the insulating unit. ST₁ is a surface tension (mN/m) of the insulating oil, and ST_{F} is a surface energy (mN/m) of the insulating unit.

### CROSS-REFERENCE TO RELATED APPLICATIONS

This application is based on and claims priority from Korean Patent Application No. 10-2025-0020436 filed on Feb. 17, 2025, with the Korean Intellectual Property Office, the disclosure of which is incorporated herein in its entirety by reference.

### TECHNICAL FIELD

The present disclosure relates to a battery packaging system and a battery pack including the same.

### BACKGROUND

Lithium secondary batteries, due to the high energy density and long lifespan, are widely used in, for example, electric vehicles (EVs), energy storage systems (ESSs), and portable electronic devices. The lithium secondary batteries, rather than being incorporated into an apparatus as a single battery cell, are designed to store large-capacity energy by packaging a plurality of battery cells to form a battery packaging system, or by including a plurality of such battery packaging systems to form a battery pack.

When a battery pack is configured by connecting a plurality of battery cells in series and/or in parallel, it is common to configure a battery packaging including at least one battery cell and to configure the battery pack by adding at least one such battery packaging and other components. The plurality of battery cells, included in such a medium- to large-sized battery packaging, charge and discharge a large amount of energy during charging and discharging, and thus generate a significant amount of heat in the process.

Accordingly, in the case of the battery packaging and/or the battery pack, a cooling system for discharging a large amount of generated heat to the outside is required.

### SUMMARY

In a battery packaging system including an insulating unit and an insulating oil, the present disclosure may prevent or suppress a swelling phenomenon caused by interaction between the insulating unit and the insulating oil by controlling the battery packaging system such that an STR represented by Equation 1 according to the present disclosure is 12.5 or more, thereby improving cell safety and electrochemical characteristics.

However, the issues to be solved by the present disclosure are not limited to those mentioned above, and other issues not mentioned will be clearly understood by those ordinarily skilled in the art from the following description.

[1] The present disclosure provides a battery packaging system including a battery packaging that accommodates a plurality of battery cells and an insulating oil. Each of the plurality of battery cells includes: an electrode lead that protrudes outward from a short side of the battery case and performs electrical connection; and an insulating unit that surrounds the electrode lead and insulates the battery case and the electrode lead from each other. The battery packaging system has an STR of about 12.5 or more, the STR being represented by Equation 1:

$$STR = \{ ( \vert {ST}_{I} - {ST}_{F} \vert ) / ( {ST}_{F} ) \} \times 100 \qquad [ Equation 1 ]$$

In Equation 1, ST₁ is a surface tension (mN/m) of the insulating oil, and ST_{F} is a surface energy (mN/m) of the insulating unit.

[2] In the present disclosure of [1], the STR may be about 19 or more.

[3] In the present disclosure of [1] or [2], a difference between the surface energy (mN/m) of the insulating unit and the surface tension (mN/m) of the insulating oil may be about 4 mN/m or more.

[4] In the present disclosure of at least one of [1] to [3], the difference between the surface energy (mN/m) of the insulating unit and the surface tension (mN/m) of the insulating oil may be about 5.5 mN/m or more.

[5] In the present disclosure of at least one of [1] to [4], the insulating unit may include polypropylene (PP).

[6] In the present disclosure of at least one of [1] to [5], the surface energy of the insulating unit may be about 25 mN/m to 35 mN/m.

[7] In the present disclosure of at least one of [1] to [6], the insulating oil may include one or more selected from a hydrocarbon-based compound and a silicone-based compound.

[8] In the present disclosure of at least one of [1] to [7], the insulating oil may include a silicone-based compound.

[9] In the present disclosure of at least one of [1] to [8], when the insulating unit is immersed in the insulating oil and left at 60° C. for three days, a thickness change rate of the insulating unit may be about 10% or less.

[10] In the present disclosure of at least one of [1] to [9], the battery packaging system may further include a circulation system that circulates the insulating oil inside the battery packaging.

[11] In the present disclosure of at least one of [1] to [10], the circulation system may include: an inlet connected to one side of the battery packaging in a length direction; and an outlet connected to the other side of the battery packaging in the length direction.

[12] The present disclosure provides a battery pack including the battery packaging system according to [1] to [11].

[13] The present disclosure provides a vehicle including the battery pack according to [12].

[14] Another embodiment of the present disclosure provides a method of controlling a battery packaging system including battery packaging configured to accommodate a plurality of battery cells and insulating oil. Each of the plurality of battery cells includes: an electrode lead that protrudes outward from a short side of the battery case and performs electrical connection; and an insulating unit that surrounds the electrode lead and insulates the battery case and the electrode lead from each other. The battery packaging system is controlled such that an STR represented by Equation 1 below is 12.5 or more.

$$STR = \{ ( \vert {ST}_{I} - {ST}_{F} \vert ) / ( {ST}_{F} ) \} \times 100 \qquad [ Equation 1 ]$$

In Equation 1, ST₁ is a surface tension (mN/m) of the insulating oil, and ST_{F} is a surface energy (mN/m) of the insulating unit.

[15] In the present disclosure of [14], the STR value may be adjusted by controlling the relationship between the surface tension (mN/m) of the insulating oil and the surface energy (mN/m) of the insulating unit.

[16] In the present disclosure of [15], the STR value may be a ratio of a difference (|ST₁−ST_{F}|) between the surface tension of the insulating oil and the surface energy (ST_{F}) of the insulating unit to the surface energy (ST_{F}) of the insulating unit.

According to the present disclosure, the battery packaging system including an insulating unit and an insulating oil is controlled such that an STR represented by Equation 1 according to the present disclosure is about 12.5 or more. With the above-described features, a swelling phenomenon caused by interaction between the insulating unit and the insulating oil may be prevented or suppressed, and thus deterioration of sealing performance of the battery cells and impairment of insulation function may be prevented or suppressed, thereby increasing the safety of the battery cells and improving the electrochemical characteristics of the battery cells.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is an exploded perspective view illustrating a battery cell included in a battery packaging system, according to an embodiment of the present disclosure.

FIG. 2 is a schematic view illustrating a battery packaging system, according to an embodiment of the present disclosure.

FIG. 3 is an exploded perspective view illustrating a battery packaging system, according to an embodiment of the present disclosure.

FIG. 4 is a schematic perspective view illustrating a vehicle including a battery pack to which a battery packaging system, according to an embodiment of the present disclosure is applied.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments.

Also, common but well-understood elements that are useful or necessary in a commercially feasible embodiment are often not depicted in order to facilitate a less obstructed view of these various embodiments.

### DETAILED DESCRIPTION

Hereinafter, with reference to the accompanying drawings, embodiments of the present disclosure will be described so that those ordinarily skilled in the art can easily implement the present disclosure. However, the present disclosure may be implemented in various different forms and is not limited or restricted by the following examples.

In order to clearly describe the present disclosure, detailed descriptions of portions unrelated to the present disclosure or known technologies that may unnecessarily obscure the gist of the present disclosure have been omitted. Additionally, when assigning reference numerals to components in each drawing in this specification, the same or similar reference numerals are assigned to the same or similar components throughout the specification.

The terms or words used in the specification and claims should not be construed as limited to their ordinary or dictionary meanings, but should be construed as having meanings and concepts consistent with the technical concept of the present disclosure based on the principle that an inventor may appropriately define the concepts of terms in order to explain the inventor's own invention in the best manner.

In the drawings, respective components of a battery packaging system according to an embodiment of the present disclosure are schematically illustrated, and, for example, sizes of the components and line thicknesses, may be somewhat exaggerated for convenience of understanding.

As used herein, terms such as “include,” “comprise,” or “have” are intended to specify the presence of stated features, numbers, steps, components, or combinations thereof, but are to be understood as not precluding the possibility of the presence or addition of one or more other features, numbers, steps, components, or combinations thereof.

As used herein, the term “battery packaging” refers to any form of aggregation of battery cells without limiting a method of assembling battery cells. For example, the battery packaging may be in the form of a battery module, or may be in the form of a battery pack including non-modularized battery cells.

In the present disclosure, the type of a “battery case” is not limited. For example, the battery case may be one of various types such as a pouch-type battery case, a cylindrical battery case, or a prismatic battery case, but may be a pouch-type battery case according to an embodiment.

As used herein, the terms “about,” “approximately,” and “substantially” are used to mean a range of the numerical value or degree, or a value close thereto, in consideration of inherent manufacturing and material tolerances (e.g., ±5%).

In the case of a battery packaging and/or a battery pack, a cooling system is required for discharging a large amount of generated heat to the outside. For example, a scheme of circulating a coolant or insulating oil within the battery packaging may be considered.

However, due to the interaction between a coolant or insulating oil and the insulating unit, the insulating unit may swell. The swelling refers to a phenomenon in which the insulating oil penetrates into the insulating unit and increases the thickness of the insulating unit. When such an issue occurs, the coolant or the insulating oil may penetrate into a battery cell to deteriorate electrochemical characteristics, and insulating performance, which is a role of the insulating unit, may be impaired.

In consideration of the above, the present disclosure provides a battery packaging system that prevents or suppress a swelling phenomenon caused by interaction between an insulating unit and insulating oil, even when the insulating oil is included.

For example, in order to address an issue of degradation of cell safety and electrochemical characteristics caused by the swelling phenomenon of an insulating unit in a battery packaging system including the insulating unit and insulating oil, the present disclosure controls the relationship between the surface tension of the insulating oil and the surface energy of the insulating unit.

Hereinafter, the present disclosure will be described with reference to the drawings.

A battery packaging system according to the present disclosure and a battery pack including the same include at least one of configurations disclosed below, and may include any combination of technically possible configurations among the configurations disclosed below.

### Battery Packaging System 11

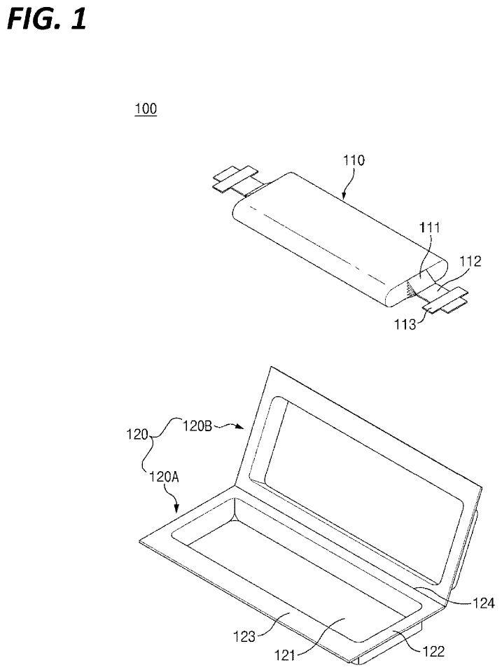

FIGS. 1 to 3 are an exploded perspective view of a battery cell 100 included in a battery packaging system 11, according to an embodiment of the present disclosure, a schematic view of the battery packaging system 11, and an exploded perspective view thereof. Hereinafter, respective configurations of the battery packaging system 11 according to the present disclosure will be described in more detail with reference to FIGS. 1 to 3.

The battery packaging system 11 according to an embodiment of the present disclosure includes a battery packaging 10 that accommodates a plurality of battery cells 100 and an insulating oil (not illustrated). Each of the battery cells 100 includes: an electrode assembly 110; a battery case 120 including an accommodation portion 121 that accommodates the electrode assembly 110 and terrace portions 122 and 123 positioned around the accommodation portion 121; an electrode lead 112 connected to the electrode assembly 110 and protruding outward from a short side of the battery case 120 to perform electrical connection; and an insulating unit 113 surrounding the electrode lead 112 and insulating the battery case 120 and the electrode lead 112 from each other.

The insulating unit 113 is positioned to correspond to a first terrace portion to be described later while surrounding the electrode lead 112, and performs both insulating and sealing functions. However, when the insulating unit 113 swells as described above, there is a risk that a sealing portion of the battery case in which the insulating unit 113 is positioned may be damaged or peeled off, causing electrolyte leakage or deterioration of insulating characteristics, which leads to degradation of battery performance and safety.

Accordingly, in order to prevent or suppress the swelling of the insulating unit 113 as described above, the present disclosure proposes, in a battery packaging system including the insulating unit 113 and an insulating oil, controlling a relationship between the surface tension of the insulating oil and the surface energy of the insulating unit such that an STR represented by Equation 1 below is about 12.5 or more.

$$STR = \{ ( \vert {ST}_{I} - {ST}_{F} \vert ) / ( {ST}_{F} ) \} \times 100 \qquad [ Equation 1 ]$$

In Equation 1, ST₁ is a surface tension (mN/m) of the insulating oil, and ST_{F} is a surface energy (mN/m) of the insulating unit.

An STR represented by Equation 1 is a ratio of a difference (|ST₁−ST_{F}|) between the surface tension of the insulating oil and the surface energy of the insulating unit to surface energy (ST_{F}) of the insulating unit. The STR is a parameter indicating a degree of deviation ratio of the surface tension of the insulating oil with respect to the surface energy of the insulating unit as a reference point.

When the STR represented by Equation 1 is about 12.5 or more, the deviation ratio of the surface tension of the insulating oil relative to the surface energy of the insulating unit does not become excessively small, and the interfacial free energy between the insulating unit and the insulating oil does not decrease. Accordingly, the insulating oil does not easily wet the insulating unit and does not readily diffuse between fine pores inside the insulating unit, thereby preventing or suppressing excessive penetration of the insulating oil into the insulating unit. As a result, swelling of the insulating unit is prevented or suppressed.

According to an embodiment of the present disclosure, the STR value represented by Equation 1 may be about 12.5 or more, for example, about 13 or more, 14 or more, 15 or more, 16 or more, 17 or more, 18 or more, or 19 or more, or may be about 121 or less, 110 or less, 100 or less, 90 or less, 80 or less, 75 or less, 70 or less, or 69 or less. According to an embodiment, the STR value may be about 19 to 69. When the above range is satisfied, interfacial free energy between the insulating unit and the insulating oil becomes relatively large, so that the insulating oil may not easily penetrate into the insulating unit, and processability may be improved.

The STR represented by Equation 1 may be controlled in various ways. For example, according to an embodiment, the STR value may be controlled by adjusting a composition of the insulating unit, a composition of compounds included in the insulating oil, additives included in the insulating unit, and a surface treatment method of the insulating unit.

According to an embodiment of the present disclosure, a difference between the surface energy (mN/m) of the insulating unit and the surface tension (mN/m) of the insulating oil may be about 4 mN/m or more, for example, about 4.2 mN/m or more, 4.4 mN/m or more, 4.6 mN/m or more, 4.8 mN/m or more, 5.0 mN/m or more, 5.1 mN/m or more, 5.2 mN/m or more, 5.3 mN/m or more, 5.4 mN/m or more, or 5.5 mN/m or more, and may be about 35 mN/m or less, 32 mN/m or less, 30 mN/m or less, 29 mN/m or less, 28 mN/m or less, 27 mN/m or less, 26 mN/m or less, or 25 mN/m or less. According to an embodiment, the difference between the surface energy of the insulating unit and the surface tension of the insulating oil may be about 5.5 mN/m to 25 mN/m. When the above range is satisfied, the interfacial tension between the insulating unit and the insulating oil is relatively high, so that the insulating oil may not easily penetrate into the insulating unit, and a cooling effect may be improved.

According to an embodiment of the present disclosure, the surface energy of the insulating unit may be smaller than the surface tension of the insulating oil. When the above condition is satisfied, the insulating oil has a strong tendency to aggregate by itself, so that the probability of penetration of the insulating oil into the insulating unit may be reduced, thereby facilitating prevention or suppression of a swelling phenomenon.

Hereinafter, a battery packaging system 11 according to the present disclosure will be described in more detail.

### (1) Insulating Unit 113

According to an embodiment of the present disclosure, the battery packaging system may include an insulating unit 113 that surrounds an electrode lead 112 and insulates a battery case 120 from the electrode lead 112. The battery packaging system may include a metal electrode lead 112 and an insulating unit 113 that surrounds the electrode lead 112 and is made of an insulating material. For example, the insulating unit 113 may be a lead film.

According to an embodiment of the present disclosure, the electrode lead 112 may protrude outward from a short side of the battery case 120 to perform electrical connection. The electrode lead 112 may be connected to an electrode assembly 110, protrude outward from the short side of the battery case 120 to perform electrical connection, and may be connected to an electrode tab 111. The electrode lead 112 may electrically connect the electrode assembly 110 to an external load.

According to an embodiment of the present disclosure, the insulating unit 113 may prevent electricity generated from the electrode assembly 110 from flowing to the battery case 120 through the electrode lead 112, and may maintain sealing of the battery case 120. To this end, the insulating unit 113 may be formed of a non-conductive material through which electricity does not readily flow. In general, the insulating unit 113 is often implemented as an insulating tape that is easily attached to the electrode lead 112 and has a relatively small thickness. However, the insulating unit 113 is not limited thereto, and any member capable of insulating the electrode lead 112 may be used.

According to an embodiment of the present disclosure, the insulating unit 113 may be disposed to surround an outer circumferential surface of the electrode lead 112. For example, a portion of the electrode lead 112 may be surrounded by the insulating unit 113. The insulating unit 113 may be positioned only at a first terrace portion 122 located around the accommodation portion 121, and may be thermally fused to inner surfaces of a first battery case 120A and a second battery case 120B.

According to an embodiment of the present disclosure, one end of the electrode lead 112 may be connected to an electrode tab 111, and the other end thereof may protrude to the outside of the battery case 120. The electrode lead 112 may include a positive electrode lead connected to a positive electrode tab and a negative electrode lead connected to a negative electrode tab. Since the positive electrode tab and the negative electrode tab are formed to protrude in various directions, the positive electrode lead and the negative electrode lead may also extend in various directions, respectively.

According to an embodiment of the present disclosure, the insulating unit 113 may surround a portion of the electrode lead 112. The insulating unit 113 may be made of an insulating material. In general, an insulating tape that is easily attached to the electrode lead 112 and has a relatively small thickness is widely used as the insulating unit 113, but the insulating unit 113 is not limited thereto.

According to an embodiment of the present disclosure, the insulating unit 113 may be positioned to correspond to a first terrace portion 122 of the battery case 120. Accordingly, the insulating unit 113 may insulate the electrode lead 112 from the first terrace portion 122.

According to an embodiment of the present disclosure, the insulating unit 113 may include various polymers such as polypropylene (PP). When the above conditions are satisfied, it may be possible to implement an appropriate surface energy and to form a more robust sealing portion through thermal fusion while maintaining insulating properties.

According to an embodiment of the present disclosure, the insulating unit 113 may be formed by laminating three layers including polypropylene (PP). For example, the insulating unit 113 may include layers sequentially laminated with acid-modified polypropylene (PPa) that is acid-modified with maleic anhydride, homopolymer polypropylene (PP), and random copolymer polypropylene (PP). When the above conditions are satisfied, it may be possible to implement excellent sealing properties while appropriately satisfying the STR range according to Equation 1 described above.

According to an embodiment of the present disclosure, the surface energy of the insulating unit 113 may be about 25 mN/m to 35 mN/m, for example, about 26 mN/m or more, 27 mN/m or more, or 28 mN/m or more, and may be about 35 mN/m or less, 34 mN/m or less, 33 mN/m or less, or 32 mN/m or less. Alternatively, the surface energy may be about 28 mN/m to 32 mN/m. When the above range is satisfied, the STR range according to Equation 1 described above may be appropriately satisfied.

The surface energy of the insulating unit 113 may be measured by various methods. For example, the surface energy of the insulating unit 113 may be measured by dropping one drop each of ultrapure water (DI water) and diiodomethane solutions onto a surface of the insulating unit 113 using a DSA100 device manufactured by KRÜSS, measuring the contact angles after 5 seconds, and then calculating the surface energy (mN/m) of the insulating unit 113 using the Owens-Wendt method.

The surface energy of the insulating unit 113 may be controlled by various methods. For example, the surface energy of the insulating unit 113 may be controlled based on a composition of the insulating unit 113, types of additives included in the insulating unit 113, and a surface treatment method of the insulating unit 113.

### (2) Insulating Oil (not Illustrated)

According to an embodiment of the present disclosure, a battery packaging system 11 according to the present disclosure may include an insulating oil.

Since the insulating oil has insulating properties, the insulating oil may circulate within the battery cells 100 included in the battery packaging 10 disposed in the battery packaging system 11, thereby serving as a coolant while preventing or suppressing electrical malfunction.

According to an embodiment of the present disclosure, any conventional insulating oil may be used as long as the insulating oil has insulating properties and is capable of serving as a coolant. However, according to an embodiment, the insulating oil may include one or more selected from hydrocarbon-based compounds and silicone-based compounds. For example, the insulating oil may include a silicone-based compound. When the above conditions are satisfied, the STR range according to Equation 1 described above may be satisfied. In addition, compared to including a general hydrocarbon-based compound, including a silicone-based compound may more easily satisfy the STR range according to Equation 1 described above. Further, by providing a difference in solubility parameter, wetting of the insulating unit by the insulating oil may be prevented or suppressed, and the insulating oil exhibits superior ability to delay ignition compared to hydrocarbon-based compounds.

According to an embodiment of the present disclosure, when the surface tension of the insulating oil is greater than the surface energy of the insulating unit 113, the surface tension of the insulating oil may be about 33 mN/m or more, for example, about 33.2 mN/m or more, 33.4 mN/m or more, 33.6 mN/m or more, 33.8 mN/m or more, 34 mN/m or more, 34.1 mN/m or more, 34.2 mN/m or more, 34.3 mN/m or more, 34.4 mN/m or more, or 34.5 mN/m or more, and may be about 64 mN/m or less, 61 mN/m or less, 59 mN/m or less, 58 mN/m or less, 57 mN/m or less, 56 mN/m or less, 55 mN/m or less, or 54 mN/m or less. According to an embodiment, the surface tension of the insulating oil may be about 34.5 mN/m to 54 mN/m. When the above range is satisfied, the STR range according to Equation 1 described above may be more easily satisfied, and the insulating oil may not easily wet the insulating unit, thereby preventing or suppressing the swelling of the insulating unit.

According to an embodiment of the present disclosure, when the surface tension of the insulating oil is smaller than the surface energy of the insulating unit 113, the surface tension of the insulating oil may be about 1 mN/m or more, for example, about 2 mN/m or more, 3 mN/m or more, or 4 mN/m or more, and may be about 25 mN/m or less, 24.8 mN/m or less, 24.6 mN/m or less, 24.4 mN/m or less, 24.2 mN/m or less, 24.0 mN/m or less, 23.9 mN/m or less, 23.8 mN/m or less, 23.7 mN/m or less, 23.6 mN/m or less, or 23.5 mN/m or less. According to an embodiment, the surface tension of the insulating oil may be about 1 mN/m to 23.5 mN/m. When the above range is satisfied, the STR range according to Equation 1 described above may be more easily satisfied, and by providing a difference in solubility parameter, wetting of the insulating unit by the insulating oil may be prevented or suppressed.

A method of measuring the surface tension of the insulating oil is not particularly limited. For example, the surface tension (mN/m) of the insulating oil may be measured three or more times by applying a Du Noüy ring method at a temperature of 25° C. using a tensiometer device (manufacturer: SEO Co., Ltd.).

The surface tension of the insulating oil may be controlled by various methods. For example, the surface tension of the insulating oil may be controlled based on a composition of compounds included in the insulating oil, types of molecules included in the compounds, and polarity of the molecules included in the compounds.

According to an embodiment of the present disclosure, when the insulating unit 113 is immersed in the insulating oil and left at 60° C. for three days, a thickness change rate of the insulating unit 113 may be about 10% or less, for example, about 5% or less, or 2.5% or less. When the above range is satisfied, even when the insulating oil performs a cooling function while retaining heat, the thickness change rate of the insulating unit is small, so that degradation of battery safety and electrochemical characteristics due to swelling of the insulating unit may be prevented or suppressed.

### (3) Circulation System 20

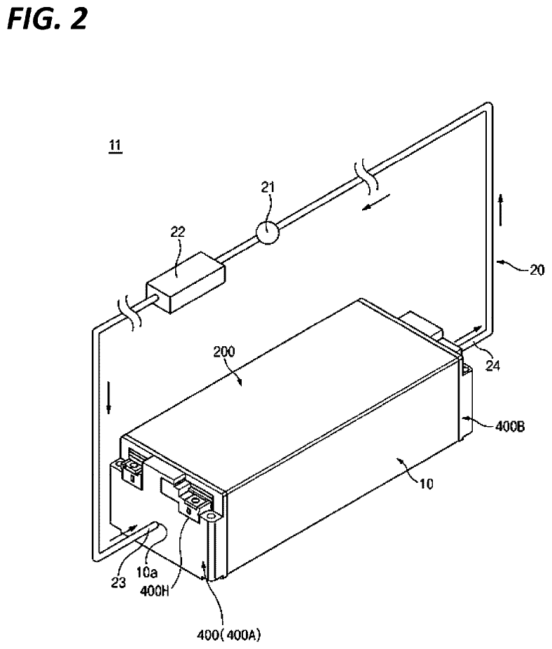

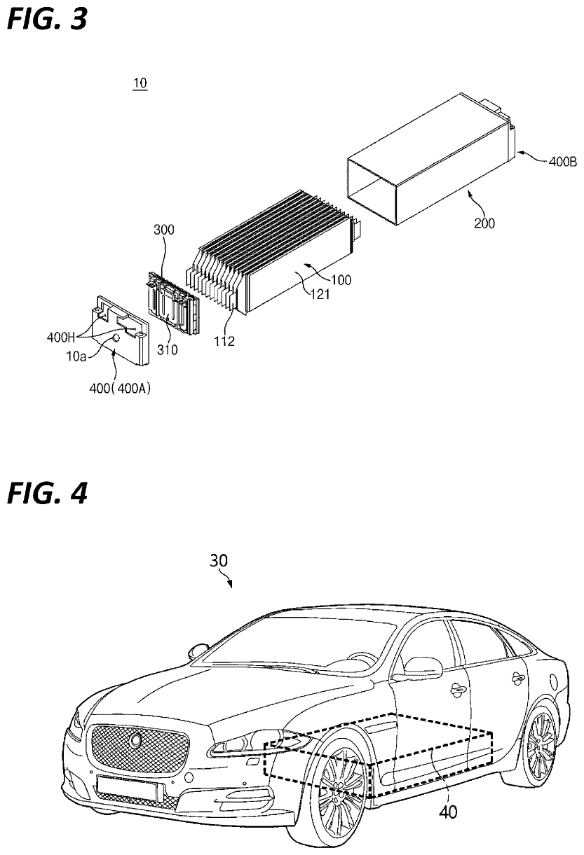

Referring to FIGS. 2 and 3, the battery packaging 10 may include a busbar frame 300 and an end cover 400.

Busbar frames 300 may be disposed on opposite sides of a plurality of battery cells 100 in a length direction. At least one busbar 310 may be mounted on each of the busbar frames 300, and each busbar 310 may be connected to an electrode lead 112 of a corresponding one of the battery cells 100. The busbars 310 may be components for electrically connecting the plurality of battery cells 100 to an external load.

The busbars 310 may be respectively mounted on the outer surfaces of the busbar frames 300. In this regard, the busbar frames 300 and the busbars 310 may have through holes through which the electrode leads 112 of the battery cells 100 pass. After passing through the through holes, the electrode leads 112 may be folded and connected to the busbars 310.

The end cover 400 may be coupled to the housing 200. End covers 400 may cover opposite open ends of the housing 200. According to an embodiment, the end covers 400 may include a first end cover 400A covering one end of the housing 200 and a second end cover 400B covering the other end of the housing 200.

An opening 400H may be formed in each end cover 400, and electrical connection of the busbar 310 may be achieved through the opening 400H.

According to an embodiment of the present disclosure, the battery packaging system 11 may further include a circulation system 20 configured to circulate the insulating oil into an interior of the battery packaging 10.

The circulation system 20 may circulate the insulating oil into the interior of the battery packaging 10. The circulation system 20 may circulate the insulating oil as a coolant into the housing 200 of the battery packaging 10 so as to cool the plurality of battery cells 100.

According to an embodiment of the present disclosure, the circulation system 20 may include an inlet 23 connected to one side of the battery packaging 10 in the length direction and an outlet 24 connected to the other side of the battery packaging 10 in the length direction. Accordingly, the insulating oil introduced into the battery packaging 10 through the inlet 23 may pass through the longest possible flow path within the interior of the battery packaging 10 and then be discharged through the outlet 24. As a result, cooling of the plurality of battery cells 100 may be effectively achieved.

According to an embodiment of the present disclosure, the circulation system 20 may include a pump 21 configured to circulate the insulating oil, a cooling unit 22 configured to cool the insulating oil, an inlet 23 through which the insulating oil flows into the housing 200 of the battery packaging 10, and an outlet 24 through which the insulating oil flows out of the housing 200.

According to an embodiment of the present disclosure, the cooling unit 22 may be disposed outside the housing 200. The cooling unit 22 may cool the insulating oil whose temperature has increased by absorbing heat from the plurality of battery cells 100 inside the housing 200.

The type of the cooling unit 22 is not limited. For example, the cooling unit 22 may include a fan or a blower configured to blow air toward the insulating oil flowing through a pipe. In addition, for efficient cooling, cooling fins may be provided on the pipe that passes through the cooling unit 22.

For example, as illustrated in FIG. 2, the inlet 23 may be connected to the first end cover 400A, and the outlet 24 may be connected to the second end cover 400B. In this case, each end cover 400 may be formed with a connection hole 10a to which the inlet 23 or the outlet 24 is connected.

However, the present disclosure is not limited thereto, and as long as a structure is capable of cooling the plurality of battery cells 100 using insulating oil, a connection configuration between the battery packaging 10 and the circulation system 20 is not limited. For example, the inlet 23 may be connected to one side of the housing 200 in the length direction, and the outlet 24 may be connected to the other side of the housing 200 in the length direction.

An operation of the circulation system 20 will now be described. By operating the pump 21, the insulating oil may be introduced into the battery packaging 10 through the inlet 23, cool the plurality of battery cells 100, and then be discharged to the outside of the battery packaging 10 through the outlet 24. Thereafter, the insulating oil may be cooled by the cooling unit 22 disposed outside the housing 200 and then reintroduced into the interior of the battery packaging 10 through the inlet 23. Through the circulation of the insulating oil repeating the above process, the plurality of battery cells 100 may be continuously cooled. Meanwhile, according to another embodiment of the present disclosure, the circulation system 20 may be disposed inside the battery packaging 10 rather than outside the battery packaging 10.

Hereinafter, a packaging system 11 according to the present disclosure will be described in more detail.

Referring back to FIG. 1, a battery cell 100 according to an embodiment of the present disclosure may include an electrode assembly 110 and a battery case 120.

The electrode assembly 110 may be formed such that a separator is interposed between a positive electrode and a negative electrode that are alternately arranged. For example, the electrode assembly 110 may include a plurality of electrodes and a plurality of separators, each of which is interposed between adjacent ones of the electrodes to electrically insulate the electrodes from each other. The electrode assembly 110 may be accommodated in the battery case 120, for example, in an accommodation portion 121.

The electrode assembly 110 may be, for example, of a stacked type, a jelly-roll type, or a stack-and-folding type, and the type of the electrode assembly 110 is not limited to any particular form.

The electrode assembly 110 may include electrode tabs 111 respectively connected to the positive electrodes and the negative electrodes. The electrode tabs 111 may serve as paths through which electrons migrate between an interior and an exterior of the electrode assembly 110. The electrode tabs 111 may include a positive electrode tab connected to the positive electrodes and a negative electrode tab connected to the negative electrodes. The positive electrode tab and the negative electrode tab may protrude from the electrode assembly 110 in different directions, but are not limited thereto, and may also be formed to protrude in various directions, such as protruding side by side in the same direction from one side.

The battery cell 100 may further include electrode leads 112 connected to the electrode assembly 110 and insulating units 113 surrounding the electrode leads 112.

The electrode leads 112 may electrically connect the electrode assembly 110 to an external load. For example, the electrode leads 112 may be connected to electrode tabs 111 of the electrode assembly 110.

Each electrode lead 112 may have one end connected to a corresponding electrode tab 111 and the other end protruding to an outside of the battery case 120. The electrode leads 112 may include a positive electrode lead connected to a positive electrode tab and a negative electrode lead connected to a negative electrode tab. Since the positive electrode tab and the negative electrode tab are formed to protrude in various directions, the positive electrode lead and the negative electrode lead may also extend in various directions, respectively.

According to an embodiment of the present disclosure, the battery case 120 may be formed by molding a pouch film laminate and may accommodate the electrode assembly 110 therein. The pouch film laminate may include a surface protective layer, a gas barrier layer, and a sealant layer that are sequentially laminated. For example, the battery case 120 manufactured by molding the pouch film laminate may include a surface protective layer, a gas barrier layer, and a sealant layer that are sequentially laminated.

The surface protective layer may form the outermost layer of the battery case 120. For example, the surface protective layer may be in contact with another battery cell or another component. Accordingly, the surface protective layer may be made of a material having high abrasion resistance, insulating properties, and strength. For example, the surface protective layer may include a polyethylene terephthalate (PET) material.

The gas barrier layer may be positioned between the sealant layer and the surface protective layer. The gas barrier layer preferably has appropriate moldability and strength and is made of a material capable of preventing penetration of moisture from the outside. For example, the gas barrier layer may include an aluminum material.

The sealant layer may form the innermost layer of the battery case 120. For example, the sealant layer may be in contact with the electrode assembly 110 and an electrolyte. In addition, the sealant layer may be thermally fused to form a sealing portion. Accordingly, the sealant layer may be made of a material having excellent insulating properties and bonding properties. For example, the sealant layer may include a polypropylene (PP) material.

The pouch film laminate may further include an auxiliary resin layer. For example, the battery case 120 manufactured by molding the pouch film laminate may further include the auxiliary resin layer.

The auxiliary resin layer may be positioned between the gas barrier layer and the surface protective layer. The auxiliary resin layer may have an appropriate elongation rate so as to alleviate, at an intermediate level, a difference between the elongation rate of the gas barrier layer and the elongation rate of the surface protective layer. For example, the auxiliary resin layer may be made of a nylon material.

According to an embodiment of the present disclosure, the battery case 120 may include a first battery case 120A in which an accommodation portion 121 configured to accommodate the electrode assembly 110 is formed, and a second battery case 120B configured to cover the accommodation portion 121.

As illustrated in FIG. 1, the first battery case 120A and the second battery case 120B may be connected to each other by a folding portion 124. In this case, the first battery case 120A and the second battery case 120B may be sealed to each other along three sides other than a side on which the folding portion 124 is formed. Hereinafter, such a case will be described as an example.

According to an embodiment of the present disclosure, some portions of the first terrace portion 122 may be sealed to each other, and other portions thereof may be sealed to the insulating units 113. For example, in some portions of the first terrace portion 122, the first battery case 120A and the second battery case 120B may be sealed to each other. In other portions of the first terrace portion 122, one surface of each of the insulating units 113 may be sealed to the first battery case 120A, and the other surface of each of the insulating units 113 may be sealed to the second battery case 120B. For example, the insulating units 113 may be sealed to the battery case 120.

In the first battery case 120A, the accommodation portion 121 may be recessed and formed to a predetermined depth. The second battery case 120B may cover the accommodation portion 121.

As illustrated in FIG. 1, the accommodation portion 121 may also be formed in the second battery case 120B. In this case, the accommodation portion 121 of the second battery case 120B may cover the accommodation portion 121 of the first battery case 120A. For example, both accommodation portions 121 may form a single accommodation space in which the electrode assembly 110 is accommodated.

However, the present disclosure is not limited thereto, and the second battery case 120B may also be formed to be flat.

According to an embodiment of the present disclosure, the battery case 120 may have an accommodation portion 121 configured to accommodate the electrode assembly 110 and terrace portions 122 and 123 positioned around the accommodation portion 121.

The battery case 120 may include the terrace portions 122 and 123 positioned around the accommodation portion 121. For example, the terrace portions 122 and 123 may be portions where the first battery case 120A and the second battery case 120B are in contact with or located adjacent to each other.

The terrace portions 122 and 123 may include first terrace portions 122 through which the electrode leads 112 protrude, and a second terrace portion 123 extending in a direction different from an extension direction of the first terrace portions 122. The first terrace portions 122 may define short sides of the battery case 120, and the second terrace portion 123 may define a long side of the battery case 120.

The first terrace portions 122 may be positioned on portions of a periphery of the accommodation portion 121. For example, the first terrace portions 122 may be positioned on opposite sides of the accommodation portion 121 in the length direction and may extend substantially in the width direction of the accommodation portion 121. The electrode leads 112 may protrude to an exterior of the battery case 120 through the first terrace portions 122.

The second terrace portion 123 may be positioned in another portion of the periphery of the accommodation portion 121. For example, the second terrace portion 123 may be positioned in one side of the accommodation portion 121 in the width direction and may extend substantially in the length direction of the accommodation portion 121. The second terrace portion 123 may connect both first terrace portions 122. The second terrace portion 123 may be positioned opposite to a folding portion 124. The second terrace portion 123 may be a portion from which the electrode leads 112 do not protrude.

The second terrace portion 123 may be folded at least once toward the accommodation portion 121. According to an embodiment, the second terrace portion 123 may be subjected to single side folding (SSF) or double side folding (DSF).

According to an embodiment of the present disclosure, the battery cell 100 may further include an electrolyte (not illustrated) injected into the battery case 120. The electrolyte serves to transport lithium ions generated by electrochemical reactions of electrodes during charging and discharging of the battery cell 100, and may include a non-aqueous organic electrolyte solution, which is a mixture of a lithium salt and organic solvents, or a polymer electrolyte. Furthermore, the electrolyte may include a solid electrolyte selected from a sulfide-based solid electrolyte, an oxide-based solid electrolyte, or a polymer-based solid electrolyte, and such a solid electrolyte may have flexibility that allows easy deformation under an external force.

Hereinafter, the present disclosure will be described with reference to examples. However, the following examples are only examples to aid understanding of the present disclosure and do not limit the scope of the present disclosure. It is obvious to those skilled in the art that various changes and modifications are possible within the scope and technical spirit of the present description, and it is natural that such changes and modifications fall within the scope of the appended claims.

### Experimental Example 1: Measurement of Surface Tension of Insulating Oil

Fourteen types of insulating oils A to N were prepared, and the surface tension of the insulating oils was measured.

In detail, with respect to the insulating oils, the surface tension (mN/m) was measured by using a tensiometer device (manufacturer: SEO Co., Ltd.) and applying a Du Noüy ring method, and the measurement was repeated three or more times. In this case, the temperature was 25° C.

In this case, the surface tension of each of the insulating oils A to N was controlled by controlling types and polarity of molecules included in the insulating oil.

The measured surface tension is shown in Table 1 below.

### Example 1: Preparation of Insulating Unit and Insulating Oil

An insulating unit (thickness: 200 μm) in which acid-modified polypropylene (PPa), which is acid-modified with maleic anhydride, homopolymer polypropylene (PP), and random copolymer polypropylene (PP) were sequentially laminated was prepared.

Thereafter, insulating oil A measured in Experimental Example 1 was prepared.

### Examples 2 to 3 and Comparative Examples 1 to 11: Preparation of Insulating Unit and Insulating Oil

An insulating unit and insulating oil were prepared in the same manner as in Example 1, except that each of insulating oils B to N measured in Experimental Example 1 was prepared.

The insulating units and insulating oils prepared in Examples 1 to 3 and Comparative Examples 1 to 11 are summarized in Table 1 below.

### Experimental Example 2: Measurement of Surface Energy of Insulating Unit

The surface energy was measured with respect to the insulating units prepared in Examples 1 to 3 and Comparative Examples 1 to 11.

In detail, one drop each of ultrapure water (DI water) and diiodomethane solutions was dropped onto a surface of each insulating unit by using a DSA100 device manufactured by KRÜSS, and contact angles were measured after 5 seconds. In this case, the surface energy (mN/m) of the insulating unit was measured by using the Owens-Wendt method.

The measured surface energy is shown in Table 1 below.

TABLE 1

| | | | Insulating | | |
|---|---|---|---|---|---|
| | Insulating oil | | unit | | |
| | | Surface | Surface | | Surface |
| | | tension | energy | | tension |
| | Type | (mN/m) | (Nm/m) | STR | difference |
| Example 1 | Insulating oil A | 14.55 | 29 | 49.83 | 14.45 |
| Example 2 | Insulating oil B | 19.52 | 29 | 32.69 | 9.48 |
| Example 3 | Insulating oil C | 34.54 | 29 | 19.10 | 5.54 |
| Comparative Example 1 | Insulating oil D | 27.28 | 29 | 5.93 | 1.72 |
| Comparative Example 2 | Insulating oil E | 26.67 | 29 | 8.03 | 2.33 |
| Comparative Example 3 | Insulating oil F | 26.82 | 29 | 7.52 | 2.18 |
| Comparative Example 4 | Insulating oil G | 25.53 | 29 | 11.97 | 3.47 |
| Comparative Example 5 | Insulating oil H | 28.55 | 29 | 1.55 | 0.45 |
| Comparative Example 6 | Insulating oil I | 27.93 | 29 | 3.69 | 1.07 |
| Comparative Example 7 | Insulating oil J | 27.04 | 29 | 6.76 | 1.96 |
| Comparative Example 8 | Insulating oil K | 27.48 | 29 | 5.24 | 1.52 |
| Comparative Example 9 | Insulating oil L | 28.83 | 29 | 0.59 | 0.17 |
| Comparative Example 10 | Insulating oil M | 31.26 | 29 | 7.79 | 2.26 |
| Comparative Example 11 | Insulating oil N | 29.3 | 29 | 1.03 | 0.3 |

According to Table 1, it can be seen that, in Examples 1 to 3, the STR values are 49.83, 32.69, and 19.10, respectively, each of which is 12.5 or more, whereas Comparative Examples show values smaller than 12.5.

### Experimental Example 3: Measurement of Thickness Increase Rate of Insulating Unit

With respect to the insulating units and the insulating oils prepared in Examples 1 to 3 and Comparative Examples 1 to 11, each insulating unit was completely immersed in the corresponding insulating oil and then left for three days at a temperature of 60° C. Thereafter, the insulating units was taken out and the thicknesses of the insulating units were measured.

A thickness increase rate of each insulating unit was calculated based on a ratio of the measured thickness to an initial thickness of the insulating unit, and the results are shown in Table 2 below.

TABLE 2

| | Thickness Increase |
|---|---|
| | Rate (%) of |
| | Insulating Unit |
| Example 1 | 0.5 |
| Example 2 | 1.2 |
| Example 3 | 0.0 |
| Comparative Example 1 | 23.9 |
| Comparative Example 2 | 22.2 |
| Comparative Example 3 | 33.4 |
| Comparative Example 4 | 19.2 |
| Comparative Example 5 | 25.7 |
| Comparative Example 6 | 21.0 |
| Comparative Example 7 | 28.1 |
| Comparative Example 8 | 23.5 |
| Comparative Example 9 | 22.9 |
| Comparative Example 10 | 13.7 |
| Comparative Example 11 | 27.4 |

Referring to Table 2, it can be seen that, in Examples 1 to 3, thickness increase rates of the insulating units are 0.5%, 1.2%, and 0%, respectively, which are significantly lower than those of Comparative Examples 1 to 11.

In view of the above results, according to a battery packaging system of an embodiment of the present disclosure, an issue of degradation of cell safety and electrochemical characteristics due to a swelling phenomenon of the insulating units occurring in the battery packaging system is addressed by controlling a relationship between the surface tension (mN/m) of the insulating oil and the surface energy of the insulating units such that an STR value represented by Equation 1 described above is 12.5 or more.

FIG. 4 is a schematic perspective view illustrating a vehicle including a battery pack 40 to which a battery packaging system according to an embodiment of the present disclosure is applied.

Referring to FIG. 4, a vehicle 30 according to an embodiment of the present disclosure may include one or more battery packs 40 as described in the previous embodiments. The vehicle 30 according to the present disclosure may be, for example, an electric vehicle, a hybrid vehicle, or a plug-in hybrid vehicle. The vehicle 30 includes various types of vehicles, such as four-wheeled vehicles, as well as two-wheeled or three-wheeled vehicles. In particular, the vehicle 30 may be operated by being fed with power from the battery pack 40 according to an embodiment of the present disclosure.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A battery packaging system comprising:
a battery packaging configured to accommodate a plurality of battery cells; and
an insulating oil,
wherein each of the plurality of battery cells includes:
an electrode lead protruding outward from a short side of the battery case and configured to perform electrical connection; and
an insulator surrounding the electrode lead and configured to insulate the battery case and the electrode lead from each other, and
wherein the battery packaging system has an STR of about 12.5 or more, the STR being represented by Equation 1:
$$STR = \{ ( \vert {ST}_{I} - {ST}_{F} \vert ) / ( {ST}_{F} ) \} \times 100 \qquad [ Equation 1 ]$$
wherein, ST₁ is a surface tension (mN/m) of the insulating oil, and ST_{F} is a surface energy (mN/m) of the insulator.

2. The battery packaging system according to claim 1, wherein the STR is about 19 or more.

3. The battery packaging system according to claim 1, wherein a difference between the surface energy (mN/m) of the insulator and the surface tension (mN/m) of the insulating oil is about 4 mN/m or more.

4. The battery packaging system according to claim 1, wherein a difference between the surface energy (mN/m) of the insulating unit and the surface tension (mN/m) of the insulating oil is about 5.5 mN/m or more.

5. The battery packaging system according to claim 1, wherein the insulator includes polypropylene (PP).

6. The battery packaging system according to claim 1, wherein the surface energy of the insulating unit is about 25 mN/m to a 35 mN/m.

7. The battery packaging system according to claim 1, wherein the insulating oil includes one or more selected from a hydrocarbon-based compound and a silicone-based compound.

8. The battery packaging system according to claim 1, wherein the insulating oil includes a silicone-based compound.

9. The battery packaging system according to claim 1, wherein, when the insulator is immersed in the insulating oil and left at 60° C. for three days, a thickness change rate of the insulator is about 10% or less.

10. The battery packaging system according to claim 1, further comprising:
a circulation system configured to circulate the insulating oil inside the battery packaging.

11. The battery packaging system according to claim 10, wherein the circulation system includes:
an inlet connected to one side of the battery packaging in a length direction; and
an outlet connected to a remaining side of the battery packaging in the length direction.

12. A battery pack comprising the battery packaging system according to claim 1.

13. A vehicle comprising the battery pack according to claim 12.

14. A control method comprising:
providing a battery packaging system including a battery packaging configured to accommodate a plurality of battery cells; and an insulating oil,
wherein each of the plurality of battery cells includes:
an electrode lead protruding outward from a short side of the battery case and configured to perform electrical connection; and
an insulator surrounding the electrode lead and configured to insulate the battery case and the electrode lead from each other; and
controlling the battery packaging system such that an STR represented by Equation 1 below is 12.5 or more:
$$STR = \{ ( \vert {ST}_{I} - {ST}_{F} \vert ) / ( {ST}_{F} ) \} \times 100 \qquad [ Equation 1 ]$$
wherein, ST₁ is a surface tension (mN/m) of the insulating oil, and ST_{F} is a surface energy (mN/m) of the insulator.

15. The control method according to claim 14, wherein the STR value is adjusted by controlling a relationship between the surface tension (mN/m) of the insulating oil and the surface energy (mN/m) of the insulator.

16. The control method according to claim 15, wherein the STR value is a ratio of a difference (|ST₁−ST_{F}|) between the surface tension of the insulating oil and the surface energy (ST_{F}) of the insulator to the surface energy (ST_{F}) of the insulator.
